(19) United States
(12) Patent Application Publication
(10) Pub. No.: US 2012/0013984 A1
(43) Pub. Date: Jan. 19, 2012

(54) JACKET AND HEAD-MOUNTED OPTICAL SYSTEM

(75) Inventor: Hiromu IKEDA, Tokyo (JP)

(73) Assignee: OLYMPUS CORPORATION, Tokyo (JP)

(21) Appl. No.: 13/179,694

(22) Filed: Jul. 11, 2011

(30) Foreign Application Priority Data
Jul. 13, 2010 (JP) 2010-158899

(51) Int. Cl. G02B 27/02

(52) U.S. Cl. 359/507

(57) ABSTRACT

A loss of cleanliness of hands is prevented even if a user manipulates optical units by directly grabbing them. Provided is a sterilizable jacket (3) that is mounted to a head-mounted optical device provided with a head-mounting unit to be secured to the head of a user and an optical unit (7) that is attached to the head-mounting unit in a manner in which the position thereof is adjustable and that supplies viewable information to the user via an eyepiece portion (7c) disposed in front of an eye of the user, including a cover portion (3a) that is secured to the optical unit (7) in a detachable manner and that can almost entirely cover the optical unit (7), wherein the cover portion (3a) has an optically transparent window portion (3c) at a position facing the eyepiece portion (7c) when the cover portion (3a) is secured to the optical unit (7).

### CROSS-REFERENCE TO RELATED APPLICATIONS

This application is based on Japanese Patent Application No. 2010-158899, the contents of which are incorporated herein by reference.

### TECHNICAL FIELD

The present invention relates to a head-mounted optical system and a jacket thereof.

In particular, it relates to a head-mounted optical system that is employed when performing a surgical operation under an endoscope and that is mounted on the head of a surgeon.

### BACKGROUND ART

In the related art, there is a known head-mounted video display device that is employed in medical practice, such as surgical operations, or the like, that has displays disposed in front of both eyes of a user, and that is mounted on the head of the user (for example, see Patent Literature 1).

This video display device disclosed in Patent Literature 1 is provided with display units including the displays and a frame unit that is connected to the display units and that secures a main body of the device to the head, wherein the display units are provided so that angles thereof relative to the frame unit can be changed, and handles grabbed by the user are secured to the display units.

In medical practice, particularly when performing a surgical operation, the hands of a surgeon must be maintained in a satisfactorily sterilized state. Therefore, items touched by the surgeon also need to be sterilized so that the surgeon's hands are not contaminated by touching them. In order to configure such a video display device so as to be sterilizable, the video display device must endure treatments with chemicals, high-temperature and high-pressure steam, etc.; therefore, an external cladding and optical elements must be constructed of metal and glass instead of synthetic resin, for example, and, furthermore, it is necessary to employ a completely sealed structure.

When such a structure is employed, the weight mounted on the head increases, which significantly decreases comfort when worn, and fatigue is caused in the neck when used for observation by wearing the device for a long time. Accordingly, in Patent Literature 1, the main body is formed as a non-sterilized structure and only the grabbing handles are configured to be sterilizable.

By sterilizing the handles in this way, when the user is a doctor, etc., the position of the display units can be adjusted during an operation by gripping the handles.

In addition, with the video display device in Patent Literature 1, because the sterilized handles are secured at positions separate from the display units, the positions of the display units can be always adjusted by using the handles, if the user is accustomed to using the device.

### CITATION LIST

### Patent Literature

{PTL 1} Japanese Unexamined Patent Application, Publication No. Hei 8-196514.

### SUMMARY OF INVENTION

### Technical Problem

In actual use, it is conceivable that the display units, instead of the handles, are unintentionally grabbed directly and manipulated if the user is not accustomed to using the device, in the event of an emergency, due to fatigue during an operation, etc. The display units include members that are hard to sterilize, such as electronic parts, optical elements, etc. As a result, when the user touches unsterilized display units, the user's hands lose their cleanliness.

The present invention provides a jacket and a head-mounted optical system that does not cause a loss of cleanliness of the hands even if a user manipulates an optical unit by directly grabbing it.

### Solution to Problem

A first aspect of the present invention provides a sterilizable jacket that is mounted to a head-mounted optical device provided with a head-mounting unit to be secured to the head of a user and an optical unit that is attached to the head-mounting unit in a manner in which a position thereof is adjustable and that supplies viewable information to the user via an eyepiece portion disposed in front of an eye of the user, including a cover portion that is secured to the optical unit in a manner that allows attaching thereto and detaching therefrom and that can almost entirely cover the optical unit, wherein the cover portion is provided with an optically transparent window portion at a position that faces the eyepiece portion when the cover portion is secured to the optical unit.

In the above-described aspect, the window portion may be formed of an optically transparent material that covers the eyepiece portion.

In addition, in the above-described aspect, the cover portion may be integrally provided with a handle that can be grabbed by the user at a position laterally disposed relative to the optical unit when the head-mounting unit is secured to the head.

In addition, in the above-described aspect, the handle may be formed of an elastic material.

In the above-described aspect, the cover portion may be formed in a shape that can be attached to and detached from the optical unit from one direction and covers the optical unit and may be provided with a locking portion that locks the cover portion to the optical unit at a position where the window portion is aligned with the eyepiece portion, so as to restrict to detachment therefrom.

In the above-described aspect, the cover portion may be provided with an auxiliary cover portion that, in a state in which the cover portion is secured to the optical unit, covers a portion of the head-mounting unit adjacent to the optical unit.

In the above-described aspect, wherein a pair of the optical units is provided corresponding to both eyes of the user, and positions thereof are adjustable in accordance with a pupillary distance, and wherein a pair of the cover portions is provided so as to separately cover the pair of the optical units.

A second aspect of the present invention provides a head-mounted optical system including a head-mounted optical device provided with a head-mounting unit to be secured to the head of a user and an optical unit that is attached to the head-mounting unit in a manner in which a position thereof is adjustable and that supplies viewable information to the user via an eyepiece portion disposed in front of an eye of the user; and any one of the above-described jackets.

### BRIEF DESCRIPTION OF DRAWINGS

FIG. 1 is a plan view showing a head-mounted optical system according to an embodiment of the present invention, as mounted on the head of a user.

FIG. 2 is a side view showing the head-mounted optical system in FIG. 1, as mounted on the head of the user.

FIG. 3 is a front view showing the head-mounted optical system in FIG. 1.

FIG. 4 is a front view showing a state in which jackets according to this embodiment are removed from display units of the head-mounted optical system in FIG. 3.

FIG. 5 is a diagram for explaining attachment of the jackets in FIG. 4 to the display units.

FIG. 6 is a diagram for explaining a state in which the jackets in FIG. 5 are attached to the display units.

FIG. 7 is a diagram showing a modification of the jackets in FIG. 6.

FIG. 8 is a front view showing a head-mounted optical system to which another modification of the jackets in FIG. 6 is attached.

FIG. 9 is a perspective view showing the jackets in FIG. 8.

FIG. 10 is a front view showing a head-mounted optical system to which another modification of the jackets in FIG. 6 is attached.

### DESCRIPTION OF EMBODIMENTS

A jacket and a head-mounted optical system according to an embodiment of the present invention will be described below with reference to the drawings.

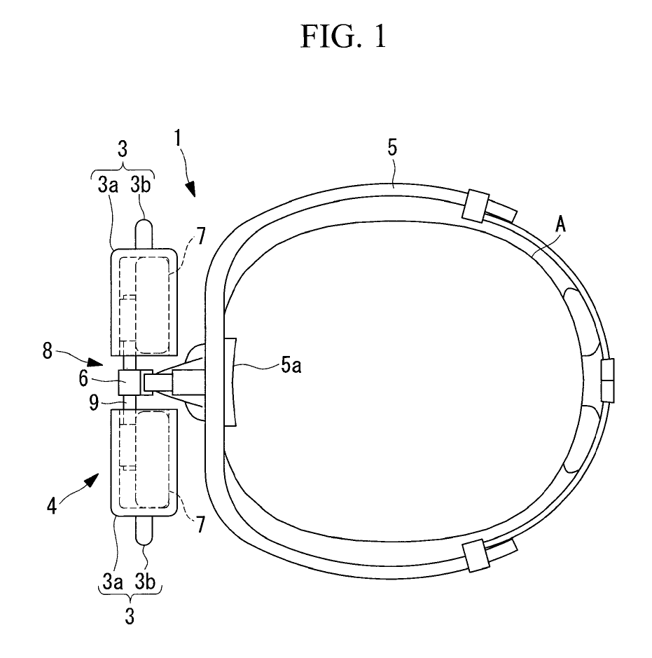

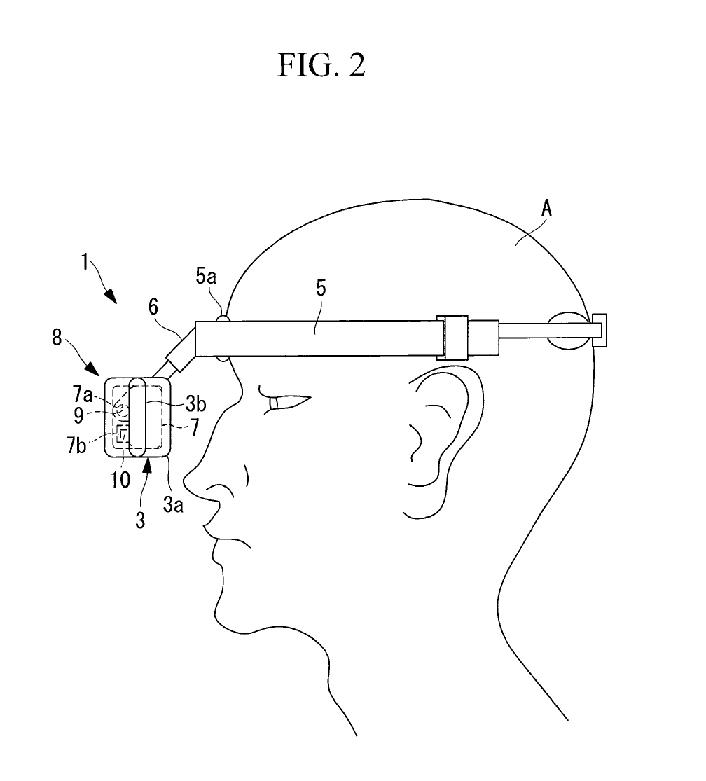

As shown in FIGS. 1 and 2, a head-mounted optical system 1 according to this embodiment is provided with a head-mounted optical device 2 and jackets 3 according to this embodiment that are secured to the head-mounted optical device 2.

The head-mounted optical device 2 is provided with an optical unit 4, a frame unit 5, and a joining portion 6 that joins them so that relative angles therebetween are adjustable.

The optical unit 4 is, for example, a display device, and includes a pair of display units (optical units) 7 that are disposed in front of both eyes of a user A and that are formed by covering optical elements, such as an LCD, prism, etc. and control circuits with external covers and a connecting portion 8 that connects the display units 7 in such a manner that the distance therebetween is adjustable. The connection portion 8 is provided with two parallel rail members 9 and 10 that are disposed so as to bridge the pair of display units 7 by being fitted to fitting holes 7a and 7b provided in each display unit 7.

By fitting the rail members 9 and 10 to the fitting holes 7a and 7b in such a manner that they can be moved relative to each other, the display units 7 are moved along a longitudinal direction of the rail members 9 and 10 so that the distance between the display units 7 can be adjusted according to the pupillary distance of the user A. By disposing the two rail members 9 and 10 parallel to each other so as to bridge the display units 7, the pair of display units 7 can always be held at the same relative angular positions.

The frame unit 5 is a circular ring-like member that wraps around the entire circumference of the head of the user A and is provided with a pad unit 5a that is pressed against the forehead of the user A. The frame unit 5 is configured so that the circumferential length thereof can be adjusted to depend on a size of the head of the user A. The frame unit 5, however, does not necessarily have to wrap around the entire circumference of the head so long as it can be secured to the head.

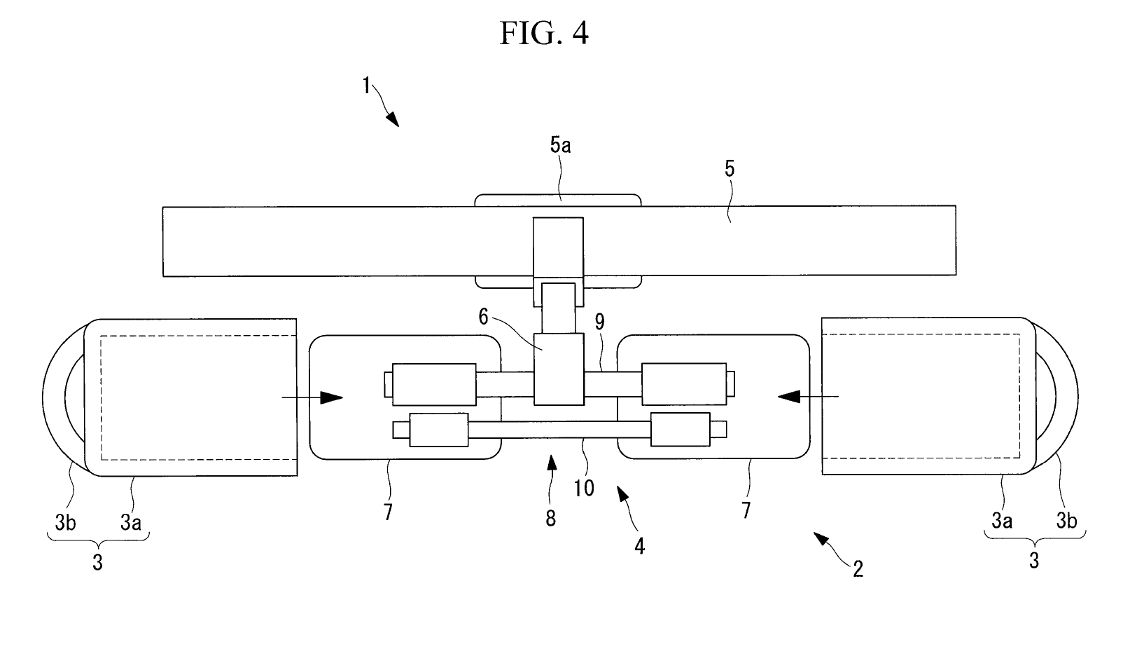

As shown in FIG. 4, the jackets 3 according to this embodiment are provided with cover portions 3a that are formed like cases, that are placed from left and right of the display units 7, and that almost entirely cover the display units 7, and arch-like curved handle portions 3b provided at one end of each cover portion 3a. The jackets 3 are entirely formed of sterilizable materials. The handle portions 3b are provided at positions that come to the left and right ends of the display units 7 when the cover portions 3a are secured to the display units 7.

Here, by attaching the jackets 3 to the display units 7, the surfaces of the display units 7 can be covered, except for surfaces thereof facing each other with the rail members 9 and 10 therebetween. Accordingly, the cover portions 3a can “almost” entirely cover the display units 7.

In addition, the jackets 3 do not necessarily have to allow repeated sterilization; they may be stored in a clean state until they are used after being manufactured in a sterilized environment and disposed of after use, and new clean jackets 3 may be used when the head-mounted optical system 1 is used next time.

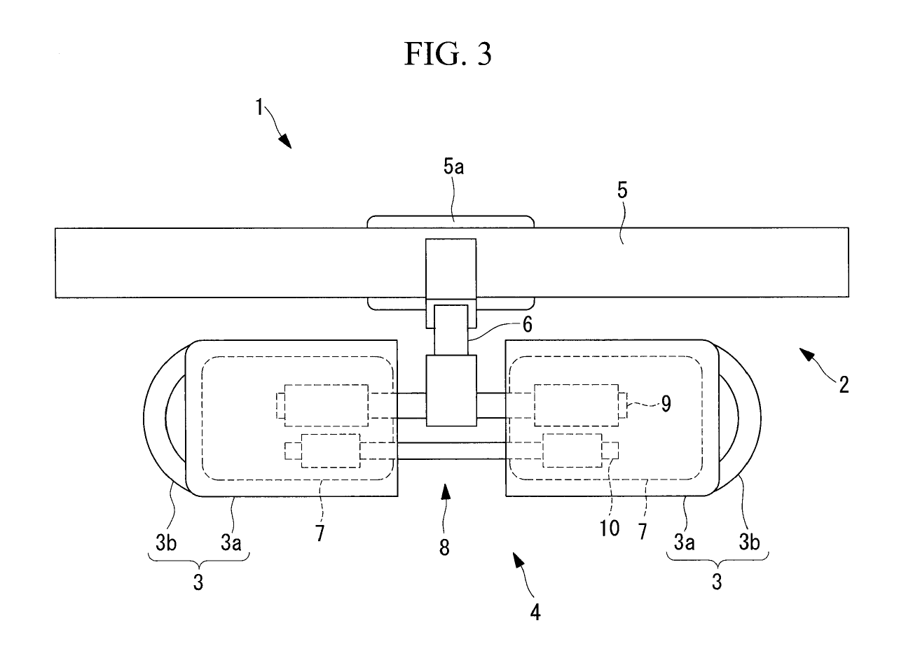

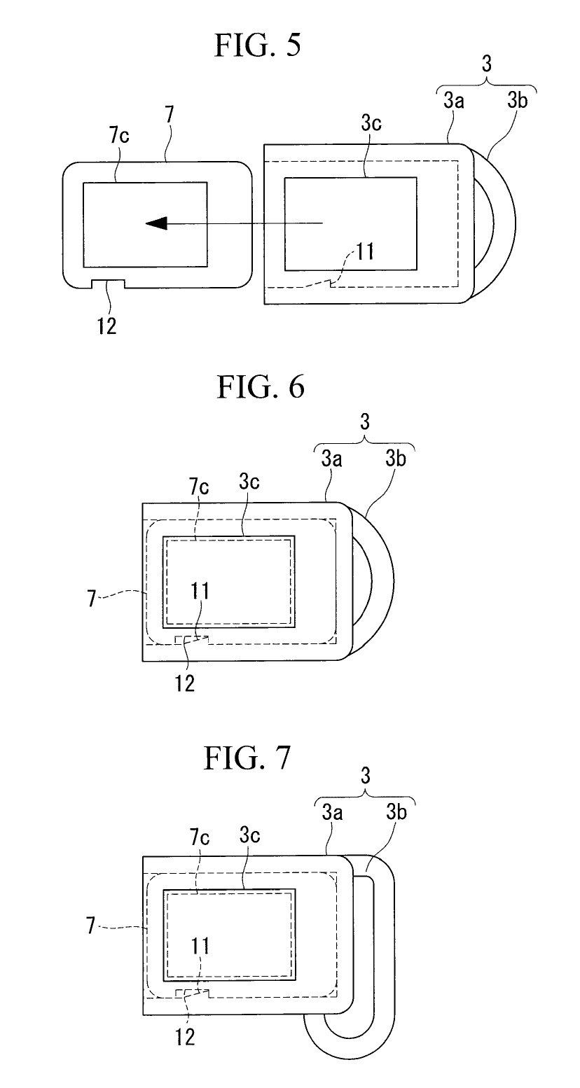

The cover portions 3a are provided with window portions 3c that are disposed at positions that, when the display units 7 are covered with the jackets 3 as shown in FIG. 3, correspond to eyepiece portions 7c provided in the display units 7, as shown in FIGS. 5 and 6.

The window portions 3c are formed of optically transparent materials so that viewable information supplied from the display units 7 is transmitted therethrough via the eyepiece portions 7c and can be supplied to the user A.

By doing so, when the cover portion 3a is secured to the optical unit 4, the optical unit 4 is almost entirely covered by the cover portion 3a, and the window portion 3c is disposed at the position that faces the eyepiece portion 7c of the optical unit 4. Therefore, by securing the head-mounted optical device 2, to which the jacket 3 according to this embodiment is attached, to the head with the frame unit 5, the user places the eyepiece portion 7c of the optical unit 4 in front of the user's eye. Since the transparent window portion 3c is disposed facing the eyepiece portion 7c, the user can obtain viewable information from the optical unit 4, which is supplied from the eyepiece portion 7c via the window portion 3c.

In this case, for example, when a doctor, who is the user, attempts to adjust the position of the optical unit 4, if the doctor moves his/her hands so as to directly grab the optical unit 4, the doctor naturally grabs the cover portion 3a that is secured to the optical unit 4 so as to almost entirely cover the optical unit 4, and the position of the optical unit 4 can be adjusted by moving the cover portion 3a. Therefore, by sterilizing the jacket 3, the user is prevented from grabbing unsterilized portions when adjusting the position of the optical unit 4 even when the user is not accustomed to using the device or in the event of an emergency, thereby preventing a loss of cleanliness of the hands.

In addition, since the window portions 3c are formed of optically transparent materials so as to cover the eyepiece portions 7c, the eyepiece portion 7c can also be covered by the cover portion 3a, and the user is more reliably prevented from grabbing unsterilized portions when adjusting the position of the optical unit 4, thereby making it possible to maintain the cleanliness of the hands.

As shown in FIGS. 5 and 6, engaging protrusions 11 are provided at inner surfaces of the cover portions 3a, and, at outer surfaces of the display units 7, engaging grooves 12 are provided that mutually engage with the engaging protrusions 11, thereby restraining them so that the jackets 3 are not detached from the display units 7. These engaging protrusions 11 and engaging grooves 12 constitute locking portions. Although FIGS. 5 and 6 show the case in which the engaging protrusions 11 are provided at the inner surfaces of the cover portions 3a and the engaging grooves 12 are provided at the outer surfaces of the display units 7, the arrangements may be reversed.

By providing the locking portion, when only the cover portion 3a is sterilized and attached from one direction so as to cover the optical unit 4, the cover portion 3a is locked to the optical unit 4 by the locking portion so as to prevent detachment from the optical unit 4. Accordingly, the attachment to the optical unit 4 can be simplified. In addition, by releasing the locking state of the locking portion, the cover portion 3a can be readily removed from the optical unit 4 and sterilized.

When the jackets 3 are placed onto the display units 7, the engaging protrusions 11 and the engaging grooves 12 engage with each other at positions where the window portions 3c face the eyepiece portions 7c, and the jackets 3 are prevented from detaching from the display units 7. On the other hand, by applying a pulling force equal to or greater than a predetermined level to the jackets 3, the engagement between the engaging protrusions 11 and the engaging grooves 12 is released, and the jackets 3 can be removed from the display units 7.

With the head-mounted optical system 1 of this embodiment, a doctor (user A) who performs a surgical operation can observe an endoscope image with the display units 7 attached to the head. The endoscope image is displayed on the display units 7 by being transmitted through a cable (not shown) that connects an endoscope system and the head-mounted optical system 1.

Control equipment that performs image adjustment in the head-mounted optical system 1, supplies power thereto, etc., as needed, may be provided between the endoscope system and the head-mounted optical system 1. The endoscope image, however, can also be wirelessly transmitted instead of using the cable. In this case, a transmitter and a receiver for the wireless transmission need to be provided in the endoscope system and the head-mounted optical system 1. The receiver provided in the head-mounted optical system 1 may be integrally formed with the head-mounted optical device 2, or it may be secured to the body of the user A and connected to the head-mounted optical device 2 via a cable.

The operation of the thus-configured jackets 3 and head-mounted optical system 1 according to this embodiment will be described below.

Since the jackets 3 according to this embodiment are formed of sterilizable materials, by sterilizing them once they are removed from the display units 7 and securing them to the display units 7 after the sterilization, the display units 7 can be almost entirely covered. Accordingly, the hands of the user A who attempts to manipulate the display units 7 can be prevented from directly touching the display units 7 which are difficult to sterilize.

Since the window portions 3c formed of the transparent materials are provided at the cover portions 3a, the viewable information supplied from the display units 7 can be smoothly supplied to the user A via the eyepiece portions 7c and the window portions 3c.

The handle portions 3b disposed at the left and right ends of the cover portions 3a attached to the display units 7 are disposed at the positions that allows the easiest manipulation when the user A attempts to adjust the positions of the display units 7; therefore, the positions of the display units 7 can be readily adjusted by grabbing the handle portions 3b. By limiting the portions grabbed by the user A to the handle portions 3b, areas touched with the hands are limited to small areas, and an advantage is afforded in that the cleanliness of the hands can be more reliably maintained.

In this way, with the jackets 3 and the head-mounted optical system 1 according to this embodiment, unlike conventional handles that are secured to positions separate from the display units 7, the display units 7 are almost entirely covered with the cover portion 3a; therefore, even if the user A unintentionally attempts to manipulate the display units 7 by directly grabbing them, if the user A is not accustomed to using the device, in the event of an emergency, due to fatigue during an operation, etc., it is possible to prevent the loss of cleanliness of the hands.

Regarding the jackets 3 and the head-mounted optical system 1 according to this embodiment, an example has been described in which the handle portions 3b are provided in the cover portions 3a; however, it is not limited thereto, and the handle portions 3b need not be provided. In addition, the shape of the handle portions 3b is arbitrary.

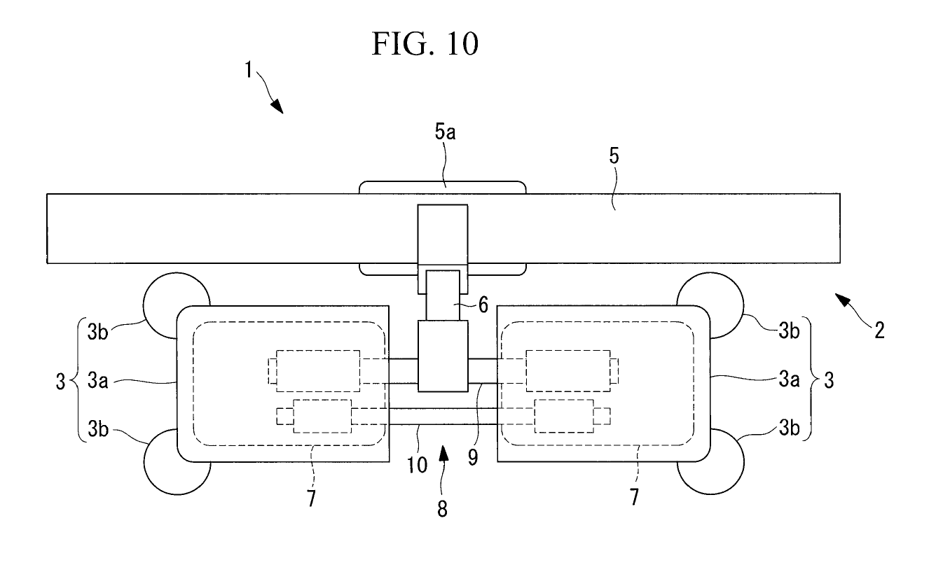

For example, protrusion-like handle portions 3b provided at corners of the cover portions 3a may be employed, as shown in FIG. 10.

In addition, by forming the handle portions 3b with elastic materials and by using the handle portions 3b as cushioning materials if the head-mounted optical device 2 is accidentally dropped, damage to the display units 7 can be prevented. In this case, as shown in FIG. 7, it is preferable that the handle portions 3b be extended from the left and right portions to lower portions thereof, thereby increasing areas that can be protected.

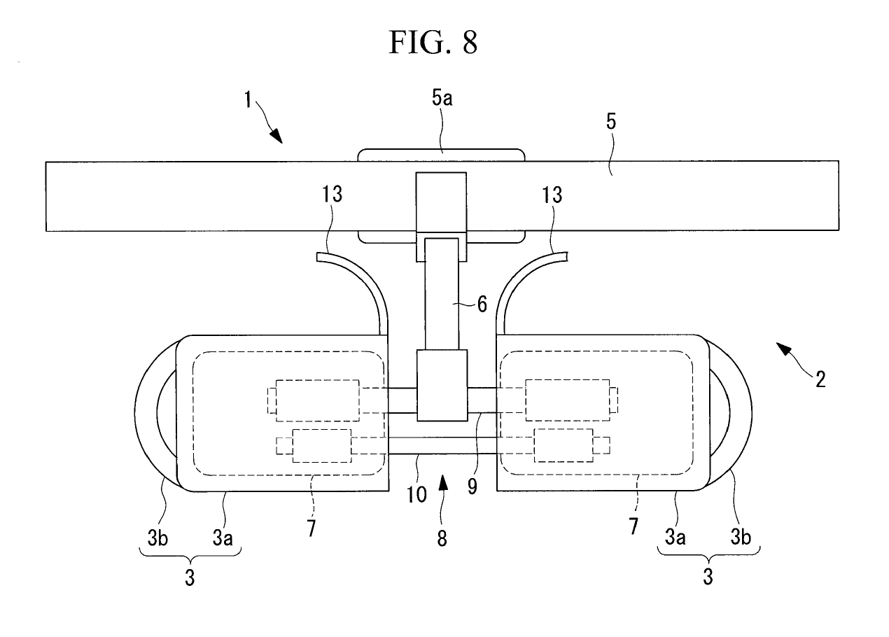

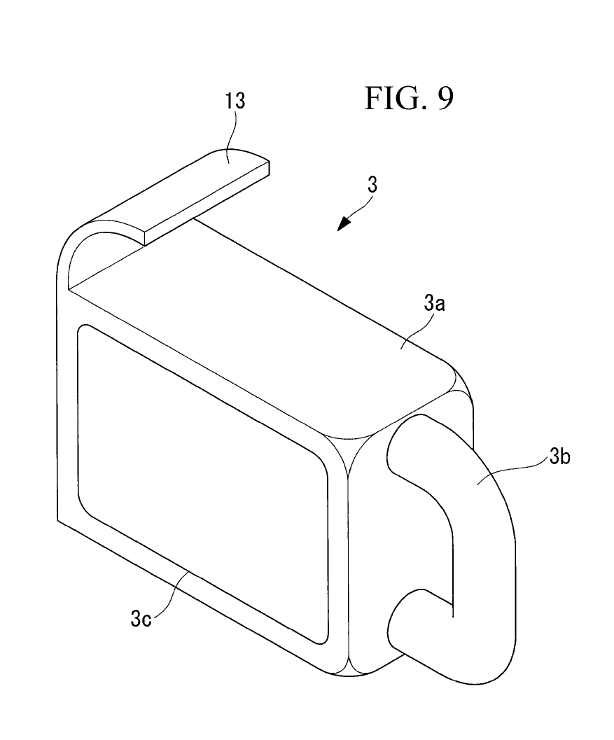

As shown in FIGS. 8 and 9, in this embodiment, the cover portions 3a may be provided with auxiliary cover portions 13 that cover portions of the joining portion 6 and the frame unit 5 when the cover portions 3a are mounted to the display units 7. By providing the auxiliary cover portions 13, it is possible to reduce the possibility of the hands of the user A, which approach from the handle portion 3b side, accidentally touching the joining portion 6 or the frame 5 and thus losing their cleanliness.

By doing so, when the cover portion 3a is secured to the optical unit 4, the auxiliary cover portion 13 covers the portion of the frame unit 5 adjacent to the optical unit 4; therefore, it is possible to prevent an inconvenience that the user's hands unnecessarily touch unsterilized portions.

Although an example has been described in which directions in which the cover portions 3a are attached to the display units 7 are the left-right directions, it is not limited thereto, and the attaching directions may be the up-down directions. Attaching from the left and right outer sides, however, is more preferable because the display units 7 can be almost entirely covered against the hands of the user A that approach the display units 7.

In addition, in this embodiment, examples of the window portions 3c that are formed of optically transparent materials have been described; however, alternatively, window portions 3c formed of opening portions may be employed, or the entire cover portions 3a may be formed of optically transparent materials.

In the jacket according to this embodiment, wherein a pair of the optical units 4 may be provided corresponding to both eyes of the user A, and positions thereof are adjustable in accordance with the pupillary distance, and wherein a pair of the cover portions 3a may be provided so as to separately cover the pair of optical units 4.

By doing so, the positions of the optical units 4 can be adjusted so as to match the pupillary distance of the user A by adjusting the distance between the pair of optical units 4, and, also during this time, the cleanliness of the hands can be maintained with the cover portions 3a that separately cover the pair of optical units 4.

### REFERENCE SIGNS LIST

A user
1 head-mounted optical system
2 head-mounted optical device
3 jacket
3a cover portion
3b handle portion (handle)
3c window portion
5 frame unit (head-mounting unit)
7 display unit (optical unit)
7c eyepiece portion
11 engaging protrusion (locking portion)
12 engaging groove (locking portion)
13 auxiliary cover portion

1. A sterilizable jacket that is mounted to a head-mounted optical device provided with a head-mounting unit to be secured to the head of a user and an optical unit that is attached to the head-mounting unit in a manner in which a position thereof is adjustable and that supplies viewable information to the user via an eyepiece portion disposed in front of an eye of the user, comprising:
a cover portion that is secured to the optical unit in a manner that allows attaching thereto and detaching therefrom and that can almost entirely cover the optical unit,
wherein the cover portion is provided with an optically transparent window portion at a position that faces the eyepiece portion when the cover portion is secured to the optical unit.

2. A jacket according to claim 1, wherein the window portion is formed of an optically transparent material that covers the eyepiece portion.

3. A jacket according to claim 1, wherein the cover portion is integrally provided with a handle that can be grabbed by the user at a position laterally disposed relative to the optical unit when the head-mounting unit is secured to the head.

4. A jacket according to claim 3, wherein the handle is formed of an elastic material.

5. A jacket according to claim 1, wherein the cover portion is formed in a shape that can be attached to and detached from the optical unit from one direction and covers the optical unit, and is provided with a locking portion that locks the cover portion to the optical unit at a position where the window portion is aligned with the eyepiece portion, so as to restrict to detachment therefrom.

6. A jacket according to claim 1, wherein the cover portion is provided with an auxiliary cover portion that, in a state in which the cover portion is secured to the optical unit, covers a portion of the head-mounting unit adjacent to the optical unit.

7. A jacket according to claim 1, wherein a pair of the optical units is provided corresponding to both eyes of the user, and positions thereof are adjustable in accordance with a pupillary distance, and
wherein a pair of the cover portions is provided so as to separately cover the pair of the optical units.

8. A head-mounted optical system comprising:
a head-mounted optical device provided with a head-mounting unit to be secured to the head of a user and an optical unit that is attached to the head-mounting unit in a manner in which a position thereof is adjustable and that supplies viewable information to the user via an eyepiece portion disposed in front of an eye of the user; and
a jacket according one of claim 1.
